(19) United States
(12) Patent Application Publication
(10) Pub. No.: US 2024/0376774 A1
(43) Pub. Date: Nov. 14, 2024

(54) GARAGE SCREEN SYSTEM

(71) Applicant: Cheryl Upshaw, Crown Point, IN (US)

(72) Inventor: Cheryl Upshaw, Crown Point, IN (US)

(21) Appl. No.: 18/195,249

(22) Filed: May 9, 2023

(51) Int. Cl. E06B 9/54; E06B 9/64; E06B 9/70

(52) U.S. Cl. CPC E06B 9/54; E06B 9/64; E06B 9/70; E06B 2009/6809

(57) ABSTRACT

A garage screen system for permitting air into an interior space of a garage while preventing entry of insects and other debris includes a mounting structure comprising a housing which mounts to a top of an opening to a garage. A spool is rotatably mounted in the housing, and a covering is wound onto the spool. The covering is extendable downwardly into an extended position in which it covers the opening. The covering comprises a flexible sheet and a rigid member. The rigid member is coupled to a distal edge of the covering with respect to the housing. The rigid member maintains a width of the flexible sheet and is weighted to facilitate unwinding the covering toward the extended position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to screen systems and more particularly pertains to a new screen system for permitting air into an interior space of a garage while preventing entry of insects and other debris.

### (2) Description of Related Art Including Information Disclosed Under 37 CFR 1.97 and 1.98

The prior art describes several screen systems for covering an opening to an interior space of a garage and preventing insects and other debris from entry into the interior space. For example, U.S. Pat. No. 6,098,698 discloses a covering which winds onto a spool mounted near a top of the opening to the interior space and which uses a motor to wind and unwind the covering to and from the spool to uncover and cover the opening respectively. This system also uses laterally spaced rails to engage the covering and a controller for operating the motor which may be in wireless communication with the motor. However, the system does not include a rigid member with retains a width of a flexible sheet of the covering and which is weighted to facilitate extending the covering to cover the opening. A system which incorporates such a rigid member is desirable in maintaining the covering over the opening over the above patent and other systems of the prior art.

### BRIEF SUMMARY OF THE INVENTION

An embodiment of the disclosure meets the needs presented above by generally comprising a garage with an interior space positioned within the garage and an opening extending through a front side of the garage to the interior space. A mounting structure is coupled to the garage and positioned in the opening. The mounting structure comprises a housing positioned at a top of the opening. A spool is mounted in the housing and is rotatable with respect to the housing around a horizontal axis extending between a pair of lateral sides of the opening. A covering is wound onto the spool in a stored position and is extendable to an extended position with respect to the spool such that the covering extends away from the spool out of the housing and covers the opening. The covering has a plurality of apertures extending through the covering, and each aperture of the plurality of apertures has a size such that the covering is configured to inhibit insects from moving through the covering. The covering comprises a flexible sheet and a rigid member. The flexible sheet is coupled to the spool, and the rigid member is coupled to and extends along a distal edge of the flexible sheet with respect to the spool. The rigid member maintains a width of the flexible sheet between a pair of lateral edges of the sheet. The rigid member is also weighted such that the rigid member facilitates extending the covering to the extended position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a garage screen system according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

FIG. 5 is a cross-section view of an embodiment of the disclosure taken from Arrows 5-5 in FIG. 2.

FIG. 6 is a block diagram of an embodiment of the disclosure.

### DETAILED DESCRIPTION OF THE INVENTION

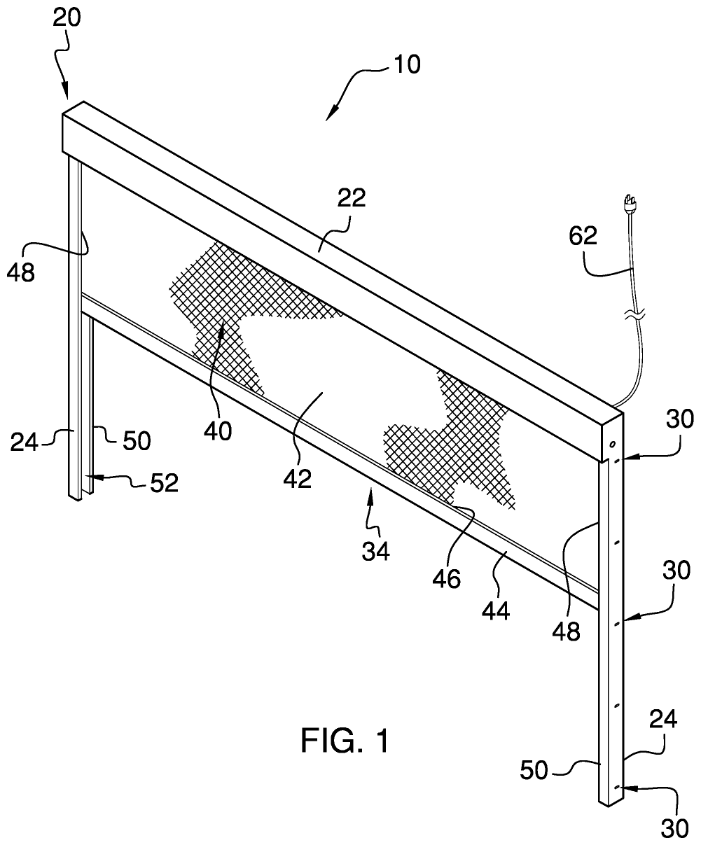

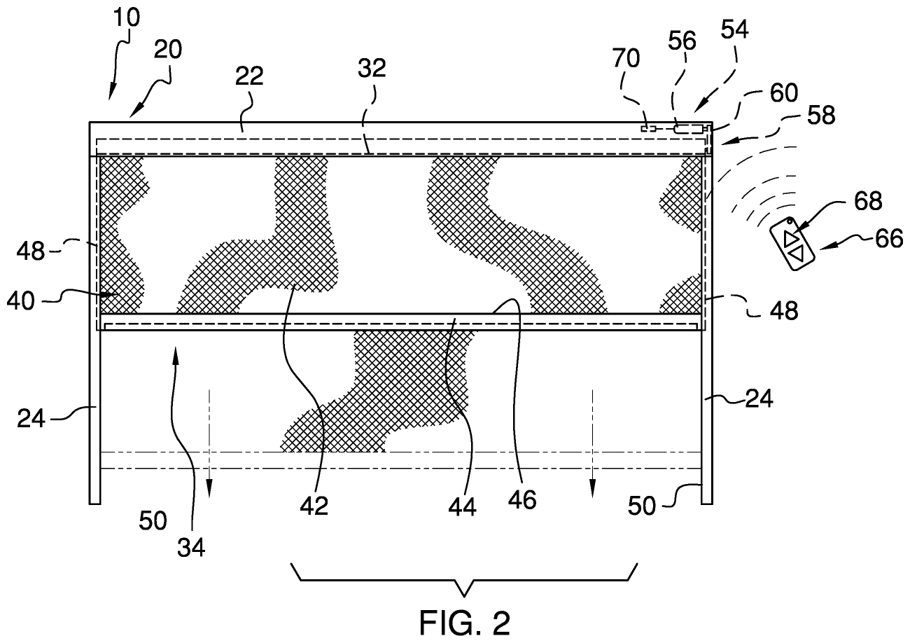

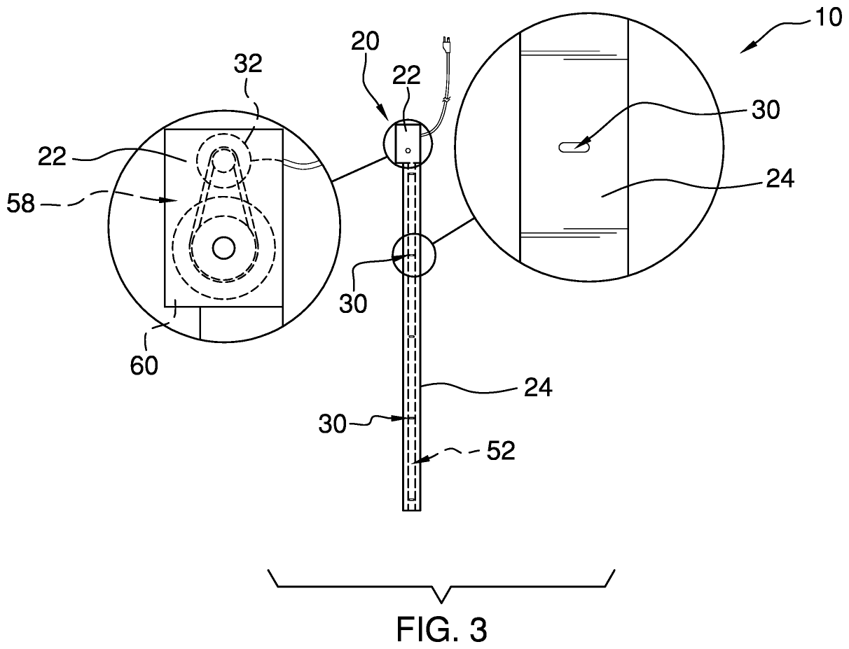

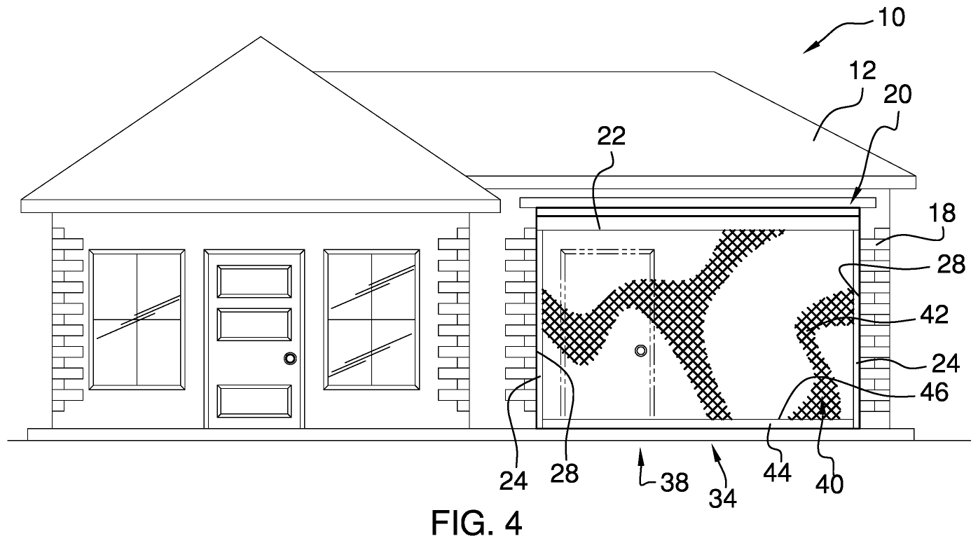

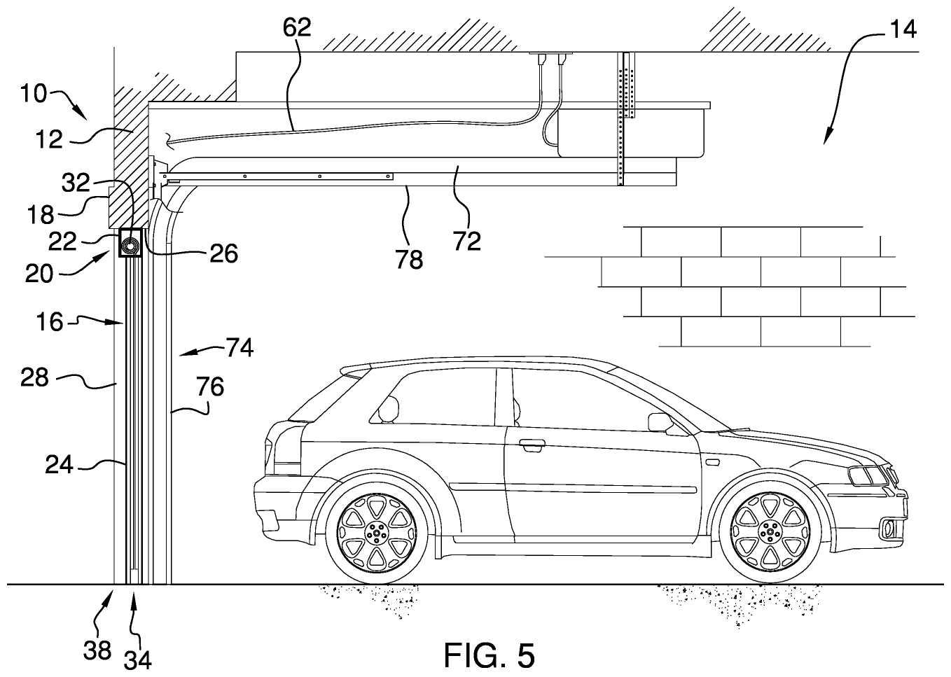

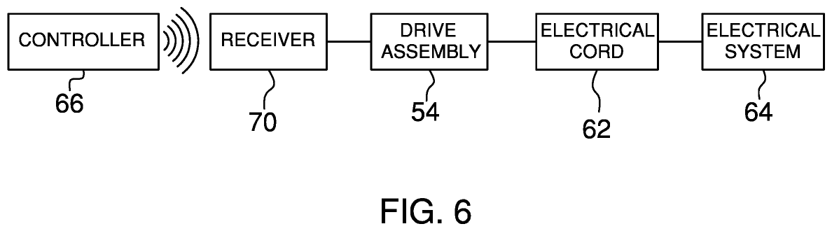

With reference now to the drawings, and in particular to FIGS. 1 through 6 thereof, a new screen system embodying the principles and concepts of an embodiment of the disclosure and generally designated by the reference numeral 10 will be described.

As best illustrated in FIGS. 1 through 6, the garage screen system 10 generally comprises a garage 12 with an interior space 14 positioned within the garage 12 and an opening 16 extending through a front side 18 of the garage 12 to the interior space 14. A mounting structure 20 is coupled to the garage 12 and positioned in the opening 16. The mounting structure 20 comprises a housing 22 positioned at a top 26 of the opening 16 and a pair of rails 24 coupled to and extending downwardly from the housing 22. Each rail 24 of the pair of rails 24 is positioned on a respective lateral side 28 of the pair of lateral sides 28 of the opening 16. Each rail 24 of the pair of rails 24 also has a plurality of mounting holes 30 extending through an associated one of the pair of rails 24 to facilitate mounting the mounting structure 20 to the garage 12 via fasteners.

A spool 32 is mounted in the housing 22 and is rotatable with respect to the housing 22 around a horizontal axis extending between a pair of lateral sides 28 of the opening 16. A covering 34 is wound onto the spool 32 in a stored position. The covering 34 is extendable to an extended position 38 with respect to the spool 32 wherein the covering 34 extends away from the spool 32 out of the housing 22 and covers the opening 16. The covering 34 has a plurality of apertures 40 extending through the covering 34, each of which having a size such that the covering 34 is configured to inhibit insects from moving through the covering 34. The covering 34 comprises a flexible sheet 42 and a rigid member 44, wherein the flexible sheet 42 is coupled to the spool 32 and the rigid member 44 is coupled to and extends along a distal edge 46 of the flexible sheet 42 with respect to the spool 32. The flexible sheet 42 comprises a mesh screen. The rigid member 44 maintains a width of the flexible sheet 42 between a pair of lateral edges 48 of the sheet. The rigid member 44 is also weighted such that the rigid member 44 facilitates extending the covering 34 to the extended position 38.

Each rail 24 of the pair of rails 24 engages the covering 34 such that the covering 34 is extendable from the spool 32 only along the pair of rails 24. Each rail 24 of the pair of rails 24 has a groove 52 extending into an inner side 50 of an associated one of the pair of rails 24 with respect to the opening 16. The groove 52 of each rail 24 of the pair of rails 24 receives the covering 34.

A drive assembly 54 is operatively coupled to the spool 32 to rotate the spool 32 alternately in a first direction and a second direction to cause the covering 34 to move toward the stored position and the extended position 38 respectively. The drive assembly 54 comprises a motor 56 and a drivetrain 58, in which the drivetrain 58 operatively coupling the motor 56 to the spool 32. The drivetrain 58 comprises a belt-and-pulley transmission 60 but may comprise a geared transmission or the like.

An electrical cord 62 is electrically coupled to the drive assembly 54 and is electrically couplable to an electrical system 64 in the garage 12 to power the drive assembly 54. A controller 66 is in communication with the drive assembly 54 and has an input 68 for selectively operating the drive assembly 54. A receiver 70 is electrically coupled to the drive assembly 54 and is in wireless communication with the controller 66.

A door 72 is slidably mounted in the garage 12 and is slidable to alternately open and close the opening 16. A pair of tracks 74 is mounted in the garage 12, and the door 72 is slidable along the pair of tracks 74. Each track 74 of the pair of tracks 74 has a vertical portion 76 positioned adjacent to and extending along the opening 16 and a horizontal portion 78 coupled to and extending rearwardly from the vertical portion 76. The vertical portion 76 of each track 74 of the pair of tracks 74 is positioned rearwardly of the mounting structure 20.

In use, the controller 66 is actuated to move the covering 34 between the stored position and the extended position 38. When the covering 34 is positioned in the extended position 38, air is permitted to alternately enter and exit the interior space 14 through the covering 34 while insects and other debris are prevented from entering and exiting the interior space 14 through the covering 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garage screen system comprising:
a garage having an interior space positioned within the garage and an opening extending through a front side of the garage to the interior space;
a mounting structure being coupled to the garage and positioned in the opening, the mounting structure comprising a housing being positioned at a top of the opening;
a spool being mounted in the housing and being rotatable with respect to the housing around a horizontal axis extending between a pair of lateral sides of the opening;
a covering being wound onto the spool in a stored position, the covering being extendable to an extended position with respect to the spool wherein the covering extends away from the spool out of the housing and covers the opening, the covering having a plurality of apertures extending through the covering, each aperture of the plurality of apertures having a size such that the covering is configured to inhibit insects from moving through the covering, the covering comprising a flexible sheet and a rigid member, the flexible sheet being coupled to the spool, the rigid member being coupled to and extending along a distal edge of the flexible sheet with respect to the spool, the rigid member maintaining a width of the flexible sheet between a pair of lateral edges of the sheet, the rigid member being weighted such that the rigid member facilitates extending the covering to the extended position.

2. The system of claim 1, wherein the mounting structure further comprises a pair of rails being coupled to and extending downwardly from the housing, each rail of the pair of rails being positioned on a respective lateral side of the pair of lateral sides of the opening, each rail of the pair of rails engaging the covering such that the covering is extendable from the spool only along the pair of rails.

3. The system of claim 2, wherein each rail of the pair of rails has a groove extending into an inner side of an associated one of the pair of rails with respect to the opening, the groove of each rail of the pair of rails receiving the covering.

4. The system of claim 2, wherein each rail of the pair of rails has a plurality of mounting holes extending through an associated one of the pair of rails to facilitate mounting the mounting structure to the garage via fasteners.

5. The system of claim 1, further comprising a drive assembly being operatively coupled to the spool to rotate the spool alternately in a first direction and a second direction to cause the covering to move toward the stored position and the extended position respectively.

6. The system of claim 5, wherein the drive assembly comprises a motor and a drivetrain, the drivetrain operatively coupling the motor to the spool.

7. The system of claim 6, wherein the drivetrain comprises a belt-and-pulley transmission.

8. The system of claim 5, further comprising an electrical cord being electrically coupled to the drive assembly, the electrical cord being electrically couplable to an electrical system in the garage to power the drive assembly.

9. The system of claim 5, further comprising a controller being in communication with the drive assembly, the controller having an input for selectively operating the drive assembly.

10. The system of claim 9, further comprising a receiver being electrically coupled to the drive assembly and being in wireless communication with the controller.

11. The system of claim 1, further comprising:
a door being slidably mounted in the garage, the door being slidable to alternately open and close the opening; and
a pair of tracks being mounted in the garage, the door being slidable along the pair of tracks, each track of the pair of tracks having a vertical portion positioned adjacent to and extending along the opening and a horizontal portion coupled to and extending rearwardly from the vertical portion, the vertical portion of each track of the pair of tracks being positioned rearwardly of the mounting structure.

12. A garage screen system comprising:
a garage having an interior space positioned within the garage and an opening extending through a front side of the garage to the interior space;
a mounting structure being coupled to the garage and positioned in the opening, the mounting structure comprising:
a housing being positioned at a top of the opening; and
a pair of rails being coupled to and extending downwardly from the housing, each rail of the pair of rails being positioned on a respective lateral side of the pair of lateral sides of the opening, each rail of the pair of rails having a plurality of mounting holes extending through an associated one of the pair of rails to facilitate mounting the mounting structure to the garage via fasteners;
a spool being mounted in the housing and being rotatable with respect to the housing around a horizontal axis extending between a pair of lateral sides of the opening;
a covering being wound onto the spool in a stored position, the covering being extendable to an extended position with respect to the spool wherein the covering extends away from the spool out of the housing and covers the opening, the covering having a plurality of apertures extending through the covering, each aperture of the plurality of apertures having a size such that the covering is configured to inhibit insects from moving through the covering, the covering comprising a flexible sheet and a rigid member, the flexible sheet being coupled to the spool, the rigid member being coupled to and extending along a distal edge of the flexible sheet with respect to the spool, the rigid member maintaining a width of the flexible sheet between a pair of lateral edges of the sheet, the rigid member being weighted such that the rigid member facilitates extending the covering to the extended position, each rail of the pair of rails engaging the covering such that the covering is extendable from the spool only along the pair of rails, each rail of the pair of rails having a groove extending into an inner side of an associated one of the pair of rails with respect to the opening, the groove of each rail of the pair of rails receiving the covering;
a drive assembly being operatively coupled to the spool to rotate the spool alternately in a first direction and a second direction to cause the covering to move toward the stored position and the extended position respectively, the drive assembly comprising a motor and a drivetrain, the drivetrain operatively coupling the motor to the spool, the drivetrain comprising a belt-and-pulley transmission;
an electrical cord being electrically coupled to the drive assembly, the electrical cord being electrically couplable to an electrical system in the garage to power the drive assembly;
a controller being in communication with the drive assembly, the controller having an input for selectively operating the drive assembly;
a receiver being electrically coupled to the drive assembly and being in wireless communication with the controller;
a door being slidably mounted in the garage, the door being slidable to alternately open and close the opening; and
a pair of tracks being mounted in the garage, the door being slidable along the pair of tracks, each track of the pair of tracks having a vertical portion positioned adjacent to and extending along the opening and a horizontal portion coupled to and extending rearwardly from the vertical portion, the vertical portion of each track of the pair of tracks being positioned rearwardly of the mounting structure.
